(19) United States
(12) Patent Application Publication
(10) Pub. No.: US 2026/0119236 A1
(43) Pub. Date: Apr. 30, 2026

(54) SELECTION OF DISTRIBUTED NEURAL PROCESSING UNITS

(71) Applicant: DELL PRODUCTS L.P., Round Rock, TX (US)

(72) Inventors: Farzad Khosrowpour, Pittsboro, NC (US); Balasingh Samuel, Round Rock, TX (US); Jacob Mink, Cedar Park, TX (US)

(21) Appl. No.: 18/931,408

(22) Filed: Oct. 30, 2024

(51) Int. Cl. G06F 9/48; G06F 9/50

(52) U.S. Cl. CPC G06F 9/4881; G06F 9/5061; G06F 2209/5019

(57) ABSTRACT

An information handling system includes a workload predictor, and a workload scheduler. The workload predictor calculates an allocation for a cost of execution of a number of operations per minute for executing an artificial intelligence workload on a first processor a second processor. The workload scheduler schedules the execution of a first portion of the artificial intelligence workload on the first processor and a second portion of the artificial intelligence workload on the second processor based upon the allocation

### FIELD OF THE DISCLOSURE

This disclosure relates to information handling systems, and more particularly relates to the selection of distributed processing units in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a workload predictor that calculates an allocation for a cost of execution of a number of operations per minute for executing an artificial intelligence workload. The information handling system may further include a workload scheduler that schedules the execution of a first portion of the artificial intelligence workload on a first processor and a second portion of the artificial intelligence workload on a second processor based upon the allocation.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a distributed system environment of information handling systems according to an embodiment of the present disclosure;

FIG. 2 is a flowchart illustrating a method for selecting distributed processing units in an information handling system according to an embodiment of the present disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

In a distributed computing environment, a single user’s artificial intelligence/machine learning (AI/ML) workloads may execute locally on the user’s information handling system or execute remotely on another information handling system or computing device. When an AI/ML workload is running on the user’s information handling system, utilizing processing elements and data storage resources of the user’s information handling system, the latency of the AI/ML workload may be lower than when the AI/ML workload is running on a remote information handling system or computing device. However, as the number of AI/ML services increases on an information handling system, the overall performance of the information handling system may be negatively impacted. For example, as the processing resources of the information handling system are increasingly given to the execution of AI/ML workloads, the information handling system may experience reduced battery life and lower system performance, and the overall end-user experience may be degraded.

Techniques to address this problem include the addition of hardware or software AI accelerators on the information handling system. However, the addition of hardware and software AI may be expensive and thus may not get integrated into low-cost platforms. When the user’s information handling system is connected to an edge network, such as a local docking station, a network connected trusted peer device, or a cloud computing environment, an information technology decision maker (ITDM) may decide to run the AI/ML workload remotely from the user’s information handling system to optimize the execution of the AI workload, and to improve the performance of the user’s information handling system.

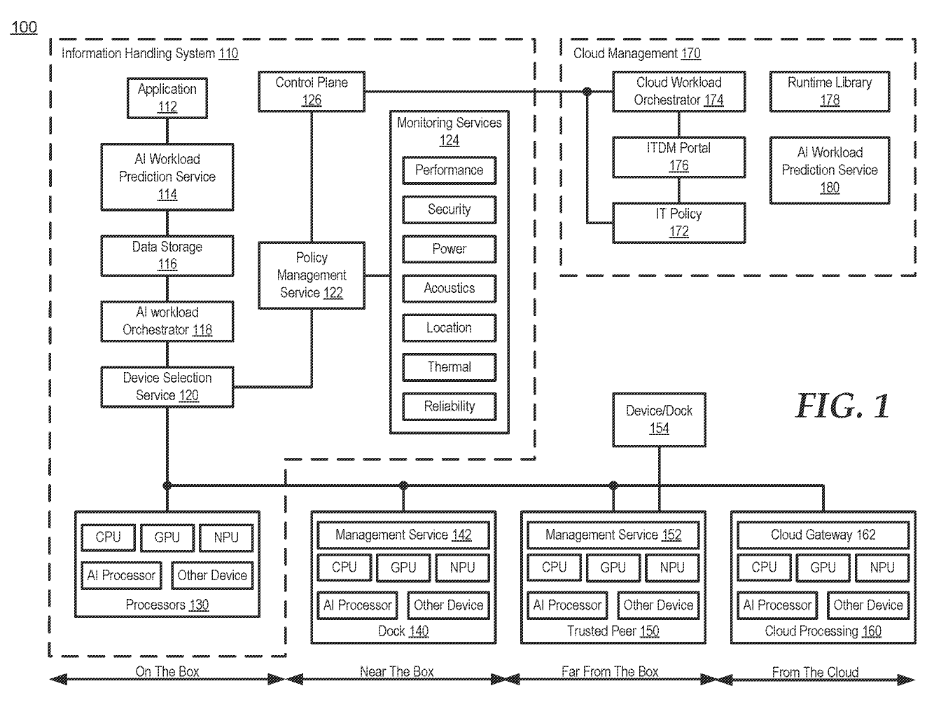

FIG. 1 illustrates a portion of a distributed system environment 100 including an information handling system 110, a docking station 140 (hereinafter “dock 140”), a trusted peer information handling system 150 (hereinafter “trusted peer 150”), cloud-based processing services 160 (hereinafter “cloud processing 160”), and cloud-based management services 170 (hereinafter "cloud management 170”). Information handling system 100 may be referred to as a “local system,” while dock 140, trusted peer 150, cloud processing 160, and cloud management 170 may each be referred to as “remote systems.” In distributed system environment 100, the local system and the remote systems are communicatively linked together by hardwired data links, wireless data links, or a combination thereof. The processing elements utilized within information handling system 110 may be characterized as being “on-the-box” processing elements, referring to the fact that such processing elements are themselves elements of the information handling system. The processing elements of distributed system environment 100 that are not included in information handling system 110 may further be characterized as being “near-the-box” processors (such as dock 140), “far-from-the-box” processors (such as trusted peer 150), or “from-the-cloud” (such as cloud processing 160).

Information handling system 110 may represent a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling system 110 may also be a portable information handling system that may include a laptop, a notebook, a smartphone, a tablet, or a personal digital assistant, among others. In one example, information handling system 110 may be an employee’s corporate laptop that he or she docks into dock 140 upon arrival at their home or office. Dock 140 includes a set of stand-alone processing capabilities that may be utilized by information handling system 100, and the information handling system may operate, when docked with the dock, to offload various processing functions to the dock, rather than to execute all the processing functions on the information handling system.

Trusted peer 150 represents an information handling system that is within a trusted network with information handling system 110, such as a corporate intranet, a virtual private network (VPN), a local area network (LAN), or the like, and that makes its processing capabilities available to be used by information handling system 110. As such, when information handling system 110 is within the trusted network, the information handling system may operate to offload various processing functions to trusted peer 150, rather than to execute all the processing functions on the information handling system.

Cloud processing 160 represents cloud-based functions, programs, processing capabilities, or the like, that are available to information handling system 100 typically over a public network such as the Internet, or the like. Information handling system 110 may operate to offload various processing functions to cloud processing 160, rather than to execute all the processing functions on the information handling system. Information handling system 110 includes various processors 130 that operate to establish a hosted environment and to execute the various processing functions of the information handling system, as needed or desired. Processors 130 include a central processing unit (CPU), a graphics processing unit (GPU), a neural-processing unit (NPU), which may include a discrete NPU (dNPU) or an integrated NPU (iNPU), an artificial intelligence (AI) processor, or other processing devices, as needed or desired. As used herein, CPUs may represent general purpose processors that execute code to perform the processing functions of a system, and particularly to set up and maintain the hosted environment of the system as needed or desired. CPUs may further be utilized to perform other processing functions as needed or desired. GPUs may represent processing devices that are dedicated to performing graphics processing operations, and may typically be understood to provide batch-based processing, as opposed to code-based processing.

NPUs may represent processing devices that are dedicated to performing neural network processing operations and may provide batch-based processing as needed or desired. As such, NPUs are optimized to handle the complex computations required by deep learning algorithms, and NPUs may be efficient at processing AI tasks, such as natural language processing, image analysis. AI processors may represent processing devices that are dedicated to performing AI processing operations and may provide batch-based processing as needed or desired. Other devices may include other types of processing devices or programmable devices such as field programmable gate array (FPGA) devices, complex programmable logic (CPLD) devices, or the like. Dock 140, trusted peer 150, and cloud processing 160 may include processing resources of their own that are similar to one or more of the elements of processors 130, and such processing resources may be referred to henceforth by reference to the particular device. For example, “the processing resources of dock 140” may henceforth be referred to as merely “dock 140,” etc.

Information handling system 110 further includes one or more applications 112, an AI workload prediction service 114, a data storage 116, an AI workload orchestrator 118, a device selection service 120, a policy management service 122, monitoring services 124, and a control plane 126. Application 112 represents an application or program installed locally on information handling system 110, and may be referred to as an on-the-box (OTB) application. AI workload prediction service 114 will be described further below. Data storage 116 represents a persistent data storage device such as a solid-state drive, a hard disk drive, or any other persistent computer-readable medium operable to store data.

AI workload orchestrator 118 operates to monitor, control, and manage AI workloads instantiated by information handling system 110, such as by executing application 120. In particular, an AI workload generally refers to data associated with an AI service that is to be performed to generate one or more inferences based on the associated data. For example, an AI workload may include a set of input data, such as telemetry data, past profile recommendations, machine learning hints from other AI services, etc., that may be processed to generate one or more inferences. As such, an AI workload may include machine learning and deep learning workloads, such as tasks performed by AI systems which typically involve processing large amounts of data and performing complex computations. For example, a typical machine learning workflow may include building a model from a sample dataset, evaluating the model against one or more additional sample datasets to decide whether to keep the model and to benchmark how good the model is, using the model in production to make predictions or decisions against live input data captured by an application. The training set, validation set, and/or test set can respectively include pairs of input datasets and output datasets that correspond to the respective input datasets. An AI workload may be executed wholly, or in part, on information handling system 110, or may be redistributed to be executed by one or more of dock 140, trusted peer 150, or cloud processing 150, as described further below. Similarly, the data utilized by the AI workload may be stored in data storage 116, such as in a database or a collection of files that are accessible by AI workload orchestrator 118.

Device selection service 120 operates to determine a physical and/or virtual device or processing element of distributed system environment 100 to which AI workloads are to be distributed for execution, and to place the AI workloads in the selected processing element. In particular, device selection service 120 utilizes information from AI workload orchestrator 118 and policy management service 122 to select a processor to execute the AI workloads, whether by one of processors 130, or by one of dock 140, trusted peer 150, or cloud processing 150. In this regard, device selection service 120 receives information related to the AI workloads and the recommended processing elements to utilize in executing the AI workloads from AI workload orchestrator 118, receives information related to the operation of information handling system 110 and policy information from policy management service 122, and synthesizes the received information to determine the device or processing element of distributed system environment 100 to which the AI workloads are to be distributed for execution. Additionally, device selection service 120 operates to determine if and when to migrate AI workloads between the processing elements of distributed system environment 100.

Policy management service 122 operates to receive operating state information for information handling system 110 and to direct the operations of the information handling system in response to the operating state. In particular, policy management service 122 implements various predefined policies for the operation of information handling system 110. As such, policy management service 122 receives the operating state information from monitoring services 124, correlates the operating state information to the various policies, and implements the policies based on the status information. The policies implemented by policy management service 122 may be provided by a user of information handling system 100, or may be received from an ITDM, for example from cloud management services 170 via control plane 126.

Monitoring services 124 operates to monitor the operating state of the various elements of information handling system 110 and to generate the operating state information. Monitoring services 124 includes various monitoring services that monitor, control, and manage an associated feature of information handling system 110. For example, monitoring service 124 may include a performance monitor, a security monitor, a power monitor, an acoustics monitor, a location monitor, a thermal monitor, a reliability monitor, or other feature monitors, as needed or desired. the performance monitor may monitor, manage, and control the performance of information handling system 110. For example, the performance monitor can collect performance metrics over time, at specified intervals, and generate logs that can be analyzed to identify system performance issues.

The security monitor may monitor, manage, and control the security of information handling system 110. For example, the security monitor can detect information security threats such as malicious attacks on information handling system 110, may detect physical security threats such as physical intrusion into the information handling system, or the like. The power monitor may monitor, manage, and the control power consumption of information handling system 110. For example, the power monitor may determine the power consumption of application 112. The acoustics monitor may monitor, manage, and control the acoustics level of information handling system 110. For example, the acoustics monitor may provide a current acoustics level of information handling system 110 and may manage a fan speed to maintain a particular acoustic output from the fan. The location monitor may include any system, device, or apparatus configured to determine the location and movement of information handling system 110, such as based on triangulation of network information or information accessible via the operating system, or a location subsystem, such as a global positioning system (GPS) module. The thermal monitor may monitor, manage, and control a temperature level of the components of information handling system 110. For example, the thermal monitor may receive temperature information from one or more temperature sensors. The reliability monitor may include any system, device, or apparatus configured to monitor, manage, and control hardware or software issues that may affect the performance and reliability of information handling system 110.

Control plane 126 controls and routes data received from cloud management services 170 to one or more components of information handling system 110, such as policy management service 122. For example, control plane 106 may route IT policy 172 to device selection service 122.

Dock 140 includes a management service 142 that operates to communicate with the elements of distributed system environment 100, and to provide an interface to the processing elements of the dock. As such, management service 142 may be invoked by device selection service 120 to select a processing device of dock 140 on which to execute an AI workload. Accordingly, management service 142 may be configured to receive an AI workload, run the AI workload locally, and then return the result to device selection service 120 for display to the user. Further, management service 142 may communicate via APIs to another information handling system, component, device, or to a cloud workload orchestrator, such as cloud workload orchestrator 174.

Similarly, trusted peer 150 includes a management service 152 that operates to communicate with the elements of distributed system environment 100, and to provide an interface to the processing elements of the trusted peer. As such, management service 152 may be invoked by device selection service 120 to select a processing device of trusted peer 150 on which to execute an AI workload. Accordingly, management service 152 may be configured to receive an AI workload, run the AI workload locally, and then return the result to device selection service 120 for display to the user. Further, management service 152 may communicate via APIs to another information handling system, component, device, or to a cloud workload orchestrator, such as cloud workload orchestrator 174. Trusted peer 150 may include a connected device 154, such as a dock similar to dock 140. In this regard, connected device 154 operates as an expansion capacity that can be utilized to execute an AI workload.

Cloud processing 160 includes a cloud gateway 162 that operates similarly to management services 142 and 152 to communicate with the elements of distributed system environment 100, and to provide an interface to the processing elements of the cloud processing. As such, cloud gateway 162 may be invoked by device selection service 120 to select a processing capability of cloud processing 160 on which to execute an AI workload. Accordingly, cloud gateway 162 may be configured to receive an AI workload, run the AI workload locally, and then return the result to device selection service 120 for display to the user. Further, cloud gateway 162 may communicate via APIs to another information handling system, component, device, or to a cloud workload orchestrator, such as cloud workload orchestrator 174.

Cloud management 170 represents a cloud-based management system for distributed system environment 100. For example, cloud management 170 may represent a management service for the elements of distributed system environment 100 and for the users of the distributed system environment, to monitor, manage, and control the operations of information handling system 110, dock 140, trusted peer 150 and cloud processing 160, as needed or desired. In particular, cloud management 170 may provide support services whereby an ITDM interacts to manage distributed system environment 100, for example, through an ITDM portal 176. In a particular embodiment, the ITDM can create, modify, and delete various IT policies 172 that can be provided to information handling system 110 via control plane 126. In another embodiment, the ITDM can direct a cloud workload orchestrator 174 to send AI workloads to information handling system 100 via control plane 126. Cloud management 170 further includes runtime libraries 178, as described further below.

It has been understood by the inventors of the current disclosure that AI workloads may be efficiently executed by dividing the tasks of the AI workloads among the various processors of the information handling system and the network connected devices. For example, various runtime management tasks associated with an AI workload may be efficiently executed by a general-purpose CPU due to the sequential nature of, for example, directing the movement of data between storage elements of the information handling system or setting up the execution of batch-based processors to perform the actual AI model processing tasks. Other execution tasks associated with the AI workload may be more efficiently executed on specialty processors such as GPUs, NPUs, AI processors, and the like, due to, for example, the parallel processing needs of the AI model. In this regard, an AI workload may be associated with various runtime libraries that direct the ability of the AI workload to be divided among the processors.

AI workload prediction service 114 operates to calculate an allocation for the cost of the number of operations per min for processors 130, dock 140, trusted peer 150, and cloud processing 160. In particular, QI workload prediction service 114 operates to determine the number of operations per minute for processors 130, dock 140, trusted peer 150, and cloud processing 160. When an AI workload is executed, AI workload prediction service 114 uses the operations per minute for processors 130, dock 140, trusted peer 150, and cloud processing 160 and input parameters and matches the input parameters with the number of operations that the AI workload requires to run on each processor, based upon the runtime library information for the AI workload. Then AI workload prediction service 114 predict the best processor on which to execute the AI workload. The runtime library information for the AI workload may be stored on data storage 116, or may be received from runtime library 178, as needed or desired. In a particular embodiment, the profiling activities of AI workload prediction service 114 may be provided wholly, or in part, by cloud management 170, as needed or desired.

In determining the processors 130, dock 140, trusted peer 150 and cloud processing 160 on which to execute AI workloads, AI workload prediction service 114 considers several factors related to the processors and the AI workloads. AI workload prediction service 114 may determine a type of the AI workload, that is, the type of AI model utilized by the AI workload, and whether or not a particular type of processor is more or less optimized to execute that type of AI workload. For example, CPUs are typically versatile and suitable for handling general-purpose tasks and sequential processing, and for tasks that are not highly parallelizable or that require complex branching operations. In contrast, GPUs excel at parallel processing due to their many cores, and are well-suited for tasks that involve large-scale matrix operations, such as deep learning training and inference models. On the other hand, NPUs or AI processors are specialized accelerators that are designed for specific tasks like neural network inference models.

AI workload prediction service 114 may further determine a degree to which an AI workload is parallelizable. For example, GPUs may be more efficient due to their many cores that can process multiple tasks simultaneously, while CPUs may not be as efficient for highly parallel tasks compared to GPUs. AI workload prediction service 114 may further determine the memory requirements for the AI workloads. For example, GPUs typically have high memory bandwidth and are optimized for tasks that require intensive memory access, such as deep learning models, while CPUs may have larger cache sizes and thus be better suited for tasks with irregular memory access patterns.

AI workload prediction service 114 may further determine the power efficiency of the various processors. For example, GPUs may be powerful for AI workloads but may consume more power compared to CPUs. On the other hand, AI workloads that that require greater energy efficiency may more suitably be executed by NPUs. AI workload prediction service 114 may further determine a performance requirement for the AI workloads. For example, AI workload prediction service 114 may further consider the speed and latency requirements of the AI workload. Here, GPUs may be known for their high throughput but may introduce greater latency compared to CPUs for certain tasks. In a particular embodiment, the functions and features of AI workload prediction service 114 may be performed wholly or in part in cloud management 170, for example by a cloud-based AI workload prediction service 180. As used herein, AI workloads may include workloads to implement supervised learning models, unsupervised learning models, clustering models, dimensionality reduction models, anomaly detection models, artificial neural network models such as deep learning models, large language models, or the like, reinforcement learning models, or other types of AI/ML models, as needed or desired.

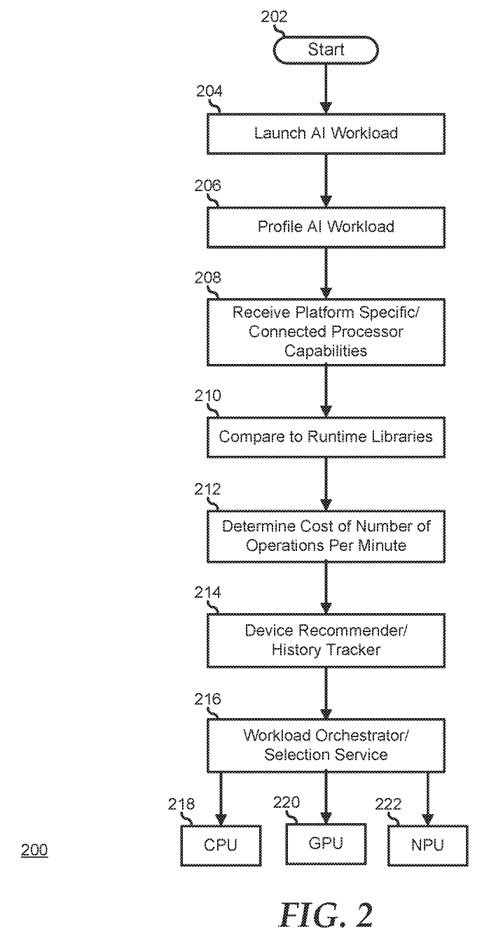

FIG. 2 illustrates a method 200 for the selection of distributed processing units in an information handling system, starting at block 202. An AI workload is selected for evaluation in block 204. The AI workload is set to be profiled by a cloud-based AI workload prediction service in block 206. The cloud-based AI workload prediction service receives the platform-specific information from an information handling system in block 208. In particular, the cloud-based AI workload prediction service receives information related to the types of processors on the information handling system and to which the information handling system is connected. The listing of the types of processors is evaluated against the runtime libraries for the specific types of processors in block 210.

The cloud-based AI workload prediction service determines the cost of the number of operations per minute for each type of processor for the workload based upon the runtime libraries in block 212. The cloud-based AI workload prediction service provides device recommendations to the information handling system and begins to track the historical performance of the execution of the AI workload in block 214. A workload orchestrator and device selection service selects the appropriate processors in block 216. The selected processors may include CPUs 218, GPUs 220, NPUs 222, or the like for the distributed execution of the AI workload.

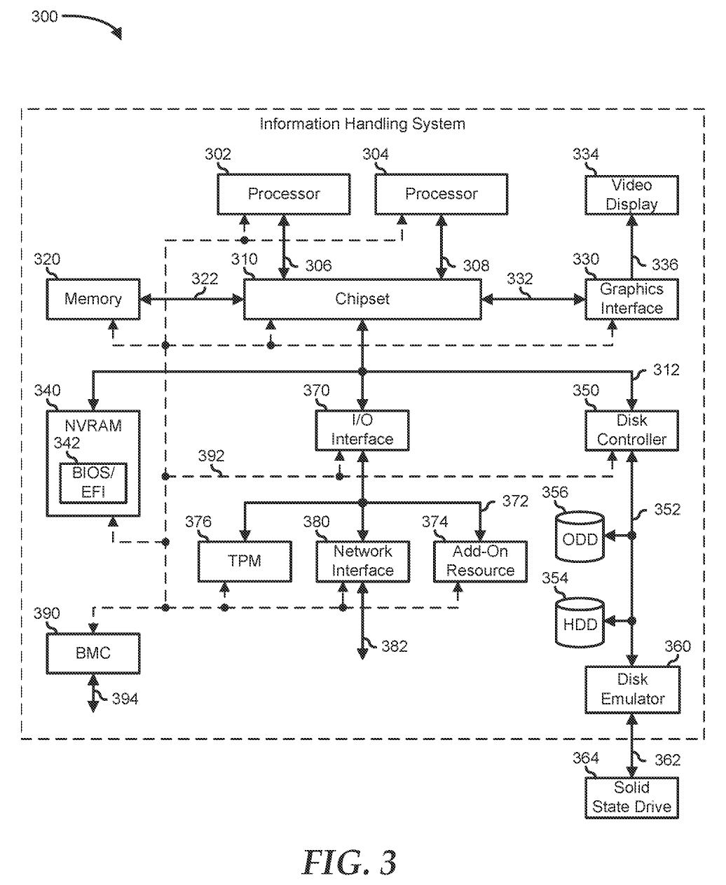

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356 , a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356 , disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system, comprising:
a first processor;
a second processor;
a workload predictor configured to calculate an allocation for a cost of execution of a number of operations per minute for executing an artificial intelligence workload on the first processor and the second processor; and
a workload scheduler configured to schedule the execution of a first portion of the artificial intelligence workload on the first processor and a second portion of the artificial intelligence workload on the second processor based upon the allocation.

2. The information handling system of claim 1, wherein in calculating the allocation, the workload predictor is further configured to determine that a first cost of execution of a first number of operations per minute for executing the first portion on the first processor is lower than a second cost of execution of a second number of operations per minute for executing the first portion on the second processor.

3. The information handling system of claim 2, wherein the workload scheduler schedules the first portion on the first processor in response to determining that the first cost is lower than the second cost.

4. The information handling system of claim 3, wherein in calculating the allocation, the workload predictor is further configured to determine that a third cost of execution of a third number of operations per minute for executing the second portion on the first processor is higher than a fourth cost of execution of a fourth number of operations per minute for executing the second portion on the second processor.

5. The information handling system of claim 4, wherein the workload scheduler schedules the second portion on the second processor in response to determining that the third cost is higher than the fourth cost.

6. The information handling system of claim 1, wherein the first processor is a general-purpose processor.

7. The information handling system of claim 6, wherein the first portion includes one of a data movement task and a set-up of a batch processor-based task.

8. The information handling system of claim 1, wherein the second processor is optimized to execute artificial intelligence workloads.

9. The information handling system of claim 8, wherein the second portion includes one of a parallel processing task and an artificial intelligence model-based task.

10. The information handling system of claim 1, wherein the allocation is determined based upon a runtime library associated with the artificial intelligence workload.

11. A method, comprising:
providing, on an information handling system, a first processor and a second processor;
providing, on the information handling system, a second processor;
providing, on the information handling system, a workload predictor;
calculating, by the workload predictor, an allocation for a cost of execution of a number of operations per minute for executing an artificial intelligence workload on the first processor and the second processor;
providing, on the information handling system, a workload scheduler; and
scheduling, by the workload scheduler, an execution of a first portion of the artificial intelligence workload on the first processor and a second portion of the artificial intelligence workload on the second processor based upon the allocation.

12. The method of claim 11, wherein in calculating the allocation, the method further comprises determining, by the workload predictor, that a first cost of execution of a first number of operations per minute for executing the first portion on the first processor is lower than a second cost of execution of a second number of operations per minute for executing the first portion on the second processor.

13. The method of claim 12, further comprising scheduling, by the workload scheduler, the first portion on the first processor in response to determining that the first cost is lower than the second cost.

14. The method of claim 13, wherein in calculating the allocation, the method further comprises determining, by the workload predictor, that a third cost of execution of a third number of operations per minute for executing the second portion on the first processor is higher than a fourth cost of execution of a fourth number of operations per minute for executing the second portion on the second processor.

15. The method of claim 14, further comprising scheduling, by the workload scheduler, the second portion on the second processor in response to determining that the third cost is higher than the fourth cost.

16. The method of claim 11, wherein the first processor is a general-purpose processor.

17. The method of claim 16, wherein the first portion includes one of a data movement task and a set-up of a batch processor-based task.

18. The method of claim 11, wherein the second processor is optimized to execute artificial intelligence workloads.

19. The method of claim 18, wherein the second portion includes one of a parallel processing task and an artificial intelligence model-based task.

20. The method of claim 11, wherein the allocation is determined based upon a runtime library associated with the artificial intelligence workload.
